(19) United States
(12) Patent Application Publication
(10) Pub. No.: US 2021/0179747 A1
(43) Pub. Date: Jun. 17, 2021

(54) Polypropylenes and Methods for Making Them

(71) Applicant: ExxonMobil Chemical Patents Inc., Baytown, TX (US)

(72) Inventors: Todd S. Edwards, League City, TX (US); Christopher G. Bauch, Seabrook, TX (US)

(21) Appl. No.: 16/759,570

(22) PCT Filed: Aug. 13, 2018
(86) PCT No.: PCT/US2018/046464

§ 371 Date: Apr. 27, 2020

Related U.S. Application Data
(60) Provisional application No. 62/607,419, filed on Dec. 19, 2017.

(51) Int. Cl. C08F 110/06; C08F 4/654; B01J 27/08; B01J 27/135; B01J 27/138

(52) U.S. Cl. CPC C08F 110/06; C08F 4/654; B01J 27/138; B01J 27/135; B01J 27/08

(57) ABSTRACT

A polypropylene comprising a xylene soluble fraction of 1.5 wt % by weight of the polymer and soluble fraction or less, wherein the polypropylene has a melt flow rate within a range from 50 g/10 min to 500 g/10 min and a flexural modulus within a range from 1780 MPa to 2200 MPa. The polypropylene is preferably made from contacting propylene with a solid magnesium/titanium catalyst component that has been washed at least once with a solvent having a desirable solubility parameter.

### PRIORITY

This application claims priority to and the benefit of U.S. Provisional Application No. 62/607,419, filed Dec. 19, 2017, which is incorporated herein by reference.

### FIELD OF THE INVENTION

The present disclosure relates to polypropylenes, and in particular to highly stereoregularity polypropylenes and methods of making them.

### BACKGROUND

A solid magnesium/titanium-based catalyst compound, or “solid catalyst component” that can produce a polypropylene that exhibits high stereoregularity in high yield is desired in order to achieve a reduction in thickness (weight) and an increase in strength with respect to a molded polypropylene article. For example, JP-A-2013-018865 discloses a method for producing a solid catalyst component that brings a magnesium compound, a tetravalent titanium halide compound, and an electron donor compound into contact with each other in the presence of an inert hydrocarbon compound solvent to effect a reaction, followed by a washing step of the resulting solid product with a hydrocarbon compound solvent, wherein the solid product is washed at least once with a hydrocarbon compound solvent that includes a halogen-containing hydrocarbon compound.

In recent years, a solid catalyst component capable of producing a polypropylene that exhibits high stereoregularity and high rigidity has been desired in order to obtain a high physical strength required for manufacturing a large molded product. According to the above method, however, since a titanium species having low stereospecificity often remains in the solid catalyst component, it may be difficult to achieve both high stereoregularity and high rigidity although the stereoregularity of the resulting polymer is improved to some extent. Therefore, a further improvement is desired.

Specifically, a solid catalyst component for propylene polymerization that is capable of producing a polypropylene that exhibits both high stereoregularity and high rigidity has been desired.

The inventors have found that the above problems can be solved by using a unique magnesium/titanium catalyst in the polymerization of propylene to effect desirable properties in the resulting polypropylene.

### SUMMARY

Disclosed is a polypropylene comprising (or consisting of, or consisting essentially of) a xylene soluble fraction of 1.5, or 1.2, or 1.0, or 0.8 wt % by weight of the polymer and soluble fraction or less, wherein the polypropylene has a melt flow rate within a range from 50, or 80, or 100, or 140 g/10 min to 220, or 300, or 400, or 500 g/10 min and a flexural modulus within a range from 1780 MPa to 2200 MPa.

In any embodiment the polypropylene is produced in a process comprising (or consisting of, or consisting essentially of) combining propylene and a solid magnesium/titanium catalyst component.

In any embodiment the solid magnesium/titanium catalyst component comprises 1.6 wt % titanium or less.

In any embodiment the solid magnesium/titanium catalyst component is made by a process comprising (or consisting of, or consisting essentially of) bringing a magnesium compound, a titanium halide compound, and one or more internal electron donor compounds into contact with each other to effect a reaction and form a reaction product; and washing the reaction product one or more times with a first inert organic solvent to produce a first intermediate product, wherein the first organic solvent does not have reactivity with the titanium halide compound, and has a solubility parameter (SP) of 8.0 to 9.0.

In any embodiment the process further comprises (or consists of, or consists essentially of) washing the first intermediate product one or more times with a second inert organic solvent to produce a second intermediate product, wherein the second intern solvent comprises a hydrocarbon compound and does not have reactivity with the titanium halide compound, but has a SP of more than 9.0.

In any embodiment the process further comprises (or consists of, or consists essentially of) washing the second intermediate product one or more times with a third inert organic solvent that does not have reactivity with the titanium halide compound, and has a SP of less than 8.0, producing a solid magnesium/titanium catalyst component.

### DETAILED DESCRIPTION

The polypropylenes disclosed herein are preferably produced by a method using a solid “magnesium/titanium” catalyst component made by a process that includes various extraction or “wash” steps using organic hydrocarbon solvents with particular solubility parameters as defined, desirably removing titanium species such as titanium chloride that has not reacted with the other components that form the solid catalyst component. This results in a polypropylene having a low xylene soluble (atactic polypropylene) content. For example, the following reactions and wash steps may occur:
bringing a magnesium compound, a titanium halide compound, and one or more internal electron donor compounds into contact with each other in the presence of an inert organic solvent to effect a reaction and form a reaction product;
washing the resulting reaction product with a “first inert organic solvent” that does not have reactivity with the titanium halide compound, and has a SP of 8.0 to 9.0 to form an intermediate product;
washing the resulting intermediate product one or more times having a reduced amount of the titanium halide compound due to the first washing with a “second inert organic solvent” that comprises a hydrocarbon compound and does not have reactivity with the titanium halide compound, but has a SP of more than 9.0; and
washing the resulting product one or more times with a “third inert organic solvent” that does not have reactivity with the titanium halide compound, and has a SP of less than 8.0.

As used herein, “wash” or “washing” includes exposing a solid and/or gel to a solvent one or more times and removing the dissolved solvent portion. “Washing” includes, for example, stirring the solid in the presence of the solvent and allowing the remaining solid to settle, then decanting the solvent or filtering the entire mixture and repeating if desired; and also includes such processes as pouring solvent over a solid on a filter or glass frit one or more times to extract soluble matter, or soxhlet extraction, or other extraction techniques known in the chemical arts.

The magnesium compound that is used in connection with the method for producing a solid catalyst component for propylene polymerization described herein may be one or more magnesium compounds selected from a dialkoxymagnesium, a magnesium dihalide, an alkoxymagnesium halide, and the like.

Among these magnesium compounds, a dialkoxymagnesium and a magnesium dihalide are preferable. Specific examples of the dialkoxymagnesium and the magnesium dihalide include dimethoxymagnesium, diethoxymagnesium, dipropoxymagnesium, dibutoxymagnesium, ethoxymethoxymagnesium, ethoxypropoxymagnesium, butoxyethoxymagnesium, magnesium dichloride, magnesium dibromide, magnesium diiodide, and the like. Among these, diethoxymagnesium and magnesium dichloride are particularly preferable.

The titanium halide compound that is used in the first step included in the method for producing a solid catalyst component for propylene polymerization described herein is not particularly limited. It is preferable that the titanium halide compound be one or more compounds selected from a titanium halide and an alkoxytitanium halide represented by the following general formula (1):

Ti(OR¹)ᵣX₄₋ᵣ, (1)

wherein R¹ is an alkyl group having 1 to 4 carbon atoms, X is (independently) a halogen atom (e.g., chlorine atom, bromine atom, or iodine atom), and “r” is an integer from 0 to 3, provided that a plurality of —OR¹ groups are either identical to or different from each other when a plurality of —OR¹ groups are present.

Examples of the titanium halide compound include a titanium tetrahalide such as titanium tetrachloride, titanium tetrabromide, and titanium tetraiodide, and an alkoxytitanium halide such as methoxytitanium trichloride, ethoxytitanium trichloride, propoxytitanium trichloride, n-butoxytitanium trichloride, dimethoxytitanium dichloride, diethoxytitanium dichloride, dipropoxytitanium dichloride, di-n-butoxytitanium dichloride, trimethoxytitanium chloride, triethoxytitanium chloride, tripropoxytitanium chloride, and tri-n-butoxytitanium chloride. Among these, a titanium tetrahalide is preferable, and titanium tetrachloride is particularly preferable. These tetravalent titanium compounds may be used either alone or in combination.

The internal electron donor compound that is used in the first step included in the method for producing a solid catalyst component for propylene polymerization described herein may be a known compound selected from organic compounds that include two or more electron donor sites, such as a hydroxy group (—OH), carbonyl group (—C(O)), ether linkage (—OR), amino group (—NH₂, —NHR, or —NHRR′), cyano group (—CN), isocyanate group (—N═C(O)), and amide linkage (—C(O)NH— or —C(O)NR—) and do not include silicon. A carbonyl group (—C(O)—) includes an aldehyde group (—C(O)H), a carboxy group (—C(O)OH), a keto group (—C(O)R), a carbonate group (—C(O)O—), an ester linkage (—C(O)OR), a urethane linkage (—NH—C(O)O—), and the like, where “R” is an alkyl or aryl group.

Among these, an ester compound such as a polycarboxylic acid ester, and an ether compound such as a diether and an ether carbonate are preferable. These internal electron donor compounds may be used either alone or in combination.

The first inert organic solvent that is used in connection with the method for producing a solid catalyst component for propylene polymerization described herein does not have reactivity with the titanium halide compound, and has a SP of 8.0 to 9.0.

It is preferable that the first inert organic solvent have a SP of 8.1 to 9.0, more preferably 8.1 to 8.9, and particularly preferably 8.4 to 8.9.

Specific examples of a compound that satisfies the above condition include an aromatic hydrocarbon compound having 6 to 20 carbon atoms, a linear or branched aliphatic hydrocarbon compound having 10 to 20 carbon atoms, and an alicyclic hydrocarbon compound having 6 to 20 carbon atoms. Among these, an aromatic hydrocarbon compound having 6 to 12 carbon atoms, a linear aliphatic hydrocarbon compound having 10 to 20 carbon atoms, and an alicyclic hydrocarbon compound having 6 to 12 carbon atoms are preferable, an aromatic hydrocarbon compound having 6 to 12 carbon atoms, such as toluene, ethylbenzene, and xylene, is more preferable, and toluene and ethylbenzene are particularly preferable.

The solubility parameter (SP) discussed herein is calculated using the following expression (2) as a square root (cal/cm³)^{0.5} of the heat of vaporization required for a liquid having a volume of 1 cm³ to vaporize:

SP={(ΔH−RT)/V}^{0.5}, (2)

where, ΔH is the molar heat of vaporization (cal/mol), R is the ideal gas constant (m²·kg/(s²·k·mol)), T is absolute temperature (Kelvin), and V is molar volume (cm³/mol).

The second inert organic solvent that is used in connection with the method for producing a solid catalyst component for propylene polymerization described herein comprises a hydrocarbon compound not having reactivity with the titanium halide compound and having a SP of more than 9.0. It is preferable that the second inert organic solvent have a SP of 9.1 to 10.9, more preferably 9.1 to 10.6, and particularly preferably 9.5 to 10.2.

Specific examples of a compound that satisfies the above condition include a halogen-containing aromatic hydrocarbon compound having 6 to 12 carbon atoms, a linear or branched halogen-containing aliphatic hydrocarbon compound having 4 to 12 carbon atoms, and a halogen-containing alicyclic hydrocarbon compound having 7 to 12 carbon atoms. Among these, a halogen-containing aromatic hydrocarbon compound having 6 to 12 carbon atoms and a linear halogen-containing aliphatic hydrocarbon compound having 4 to 6 carbon atoms are preferable, a halogen-containing aromatic hydrocarbon compound having 6 to 12 carbon atoms such as chlorobenzene (SP=9.8), o-dichlorobenzene (SP=10.0), dibromoethane (SP=10.4), and 1-bromonaphthalene (SP=10.6), is more preferable, and chlorobenzene and o-dichlorobenzene are particularly preferable.

It is possible to efficiently remove a titanium species that remains in the solid catalyst component for propylene polymerization, and easily forms an active site having low stereospecificity, by washing the resulting intermediate product with the second inert organic solvent comprising a hydrocarbon compound whose SP falls within the above range.

The third inert organic solvent that is used in connection with the method for producing a solid catalyst component for propylene polymerization described herein does not have reactivity with the titanium halide compound, and has a SP of less than 8.0. It is preferable that the third inert organic solvent have a SP of 6.3 to 7.9, more preferably 7.0 to 7.9, and particularly preferably 7.3 to 7.6.

Specific examples of a compound that satisfies the above condition include a linear or branched aliphatic hydrocarbon compound having 6 to 10 carbon atoms and an alicyclic hydrocarbon compound having 5 to 6 carbon atoms. Among these, a linear aliphatic hydrocarbon compound having 6 to 8 carbon atoms and an alicyclic hydrocarbon compound having 6 carbon atoms are preferable, an aliphatic hydrocarbon compound having 6 to 8 carbon atoms, such as n-hexane (SP=7.3), n-heptane (SP=7.4), and n-octane (SP=7.6), decane (SP=6.6) and dodecane (SP=7.9) is more preferable, and n-hexane and n-heptane are particularly preferable.

According to a preferred embodiment, the method for producing a solid catalyst component for propylene polymerization described herein includes:
performing a first step that brings a magnesium compound, a titanium halide compound, and a first internal electron donor compound into contact with each other to effect a reaction, and washing the resulting reaction product with a first inert organic solvent to form a first intermediate product (i), such “first inert organic solvent” not having reactivity with the titanium halide compound, and having a SP of 8.0 to 9.0;
performing a second step that brings a second internal electron donor compound into contact with the first intermediate product (i) to effect a reaction and form a second intermediate product, and washing the resulting product with the same or different first inert organic solvent to afford a second intermediate product (ii);
optionally performing a third step that brings a third internal electron donor compound into contact with the second intermediate product (ii) to effect a reaction, and washing the resulting intermediate product (iii) with the same or different first inert organic solvent;
performing a fourth step that washes the second intermediate product (ii) or (iii) one or more times with a “second inert organic solvent” that comprises a hydrocarbon compound not having reactivity with the titanium halide compound and having a SP of more than 9.0, resulting in washed product (iv), resulting in a third intermediate product; and
washing the third intermediate product (iv) one or more times with a “third inert organic solvent” that does not have reactivity with the titanium halide compound, the third inert organic solvent having a SP of less than 8.0, resulting in the solid catalyst component.

In particular, in the first step of making the solid catalyst component, the magnesium compound, the titanium halide compound, and the first internal electron donor compound are brought into contact with each other to effect a reaction, and the resulting product is washed with the first inert organic solvent that has a SP of 8.0 to 9.0.

The magnesium compound, the titanium halide compound, and the first inert organic solvent are the same as those mentioned above in connection with the method for producing a solid catalyst component for propylene polymerization described herein.

The first internal electron donor compound may be one or more compounds selected from aromatic dicarboxylic acid diesters (phthalic acid diester and substituted phthalic acid diester) represented by the following general formula (3):

(R²)ⱼC₆H₄₋ⱼ(C(O)OR³)(C(O)OR⁴), (3)

wherein R² is an alkyl group having 1 to 8 carbon atoms or a halogen atom, provided that a plurality of R groups are either identical to or different from each other when a plurality of R² are present, R³ and R⁴ are an alkyl group having 1 to 12 carbon atoms, provided that R³ and R⁴ are either identical to or different from each other, and “j” that represents the number of substituents R², is 0, 1, or 2, provided that the two R groups are either identical or different when j is 2.

In the second step, the titanium halide compound and the second internal electron donor compound are brought into contact with the intermediate product obtained by the first step to effect a reaction, and the resulting product is washed with the first inert organic solvent that has a SP of 8.0 to 9.0.

The titanium halide compound and the first inert organic solvent are the same as those mentioned above in connection with the method for producing a solid catalyst component for propylene polymerization described herein. The second internal electron donor compound may be one or more compounds selected from those mentioned above in connection with the method for producing a solid catalyst component for propylene polymerization described herein. More specifically, an ester compound such as a polycarboxylic acid ester, and an ether compound such as a diether and an ether carbonate, are preferable, and an aromatic dicarboxylic acid diester (phthalic acid diester and substituted phthalic acid diester) is particularly preferable.

In any embodiment, in the third step the third internal electron donor compound is brought into contact with the intermediate product obtained by the second step having a reduced amount of the titanium halide compound due to the washing to effect a reaction, and the resulting product is washed with the first inert organic solvent that has a SP of 8.0 to 9.0.

The third internal electron donor compound may be one or more compounds selected from those mentioned above in connection with the method for producing a solid catalyst component for propylene polymerization described herein.

More specifically, an ester compound such as a polycarboxylic acid ester, and an ether compound such as a diether and an ether carbonate, are preferable, and an aliphatic dicarboxylic acid diester and an aromatic dicarboxylic acid diester (phthalic acid diester and substituted phthalic acid diester) are particularly preferable.

The magnesium atom content in the solid catalyst component for propylene polymerization obtained by the production method described herein is preferably 10 to 30 wt %, more preferably 10 to 25 wt %, and yet more preferably 15 to 25 wt %.

The titanium atom content in the solid catalyst component is preferably 0.5 to 4.5 wt %, more preferably 0.5 to 3.5 wt %, and still more preferably 0.7 to 2.0 wt %.

The content of the first internal electron donor compound in the solid catalyst component is preferably 3 to 25 wt %, more preferably 5 to 20 wt %, and particularly preferably 8 to 18 wt %.

In any embodiment the content of the second internal electron donor compound in the solid catalyst component is preferably 1 to 20 wt %, more preferably 1 to 15 wt %, and particularly preferably 1 to 10 wt %.

In any embodiment the content of the third internal electron donor compound in the solid catalyst component is preferably 1 to 15 wt %, more preferably 1 to 10 wt %, and particularly preferably 1 to 8 wt %.

The total content of the first internal electron donor compound, the second internal electron donor compound, and the third internal electron donor compound in the solid catalyst component is preferably 5 to 30 wt %, more preferably 8 to 25 wt %, and particularly preferably 10 to 25 wt %.

In order to ensure that the solid catalyst component for propylene polymerization obtained by the production method described herein exhibits well-balanced overall performance, it is preferable that the titanium content be 0.5 to 2.0 wt %, the magnesium content be 15 to 25 wt %, and the content of the first internal electron donor compound be 8 to 18 wt %. In any embodiment the content of the second internal electron donor compound is 1 to 10 wt %, and the content of the third internal electron donor compound, when present, be 0 to 8 wt %.

### Polymerization Catalyst

A propylene polymerization catalyst, that is, the solid catalyst component along with other components needed to effect olefin polymerization, is described here. In particular, the propylene polymerization catalyst described herein is produced by bringing a solid catalyst component for propylene polymerization obtained by the production method described herein, an organoaluminum compound represented by the following general formula (4), and an external electron donor compound into contact with each other:

R⁵ₚAlQ₃₋ₚ, (4)

wherein R⁵ is an alkyl group having 1 to 6 carbon atoms, Q is a hydrogen atom or a halogen atom, and “p” is a real number that satisfies 0<p≤3.

The organoaluminum compound represented by the general formula (4) may be one or more compounds selected from triethylaluminum, diethylaluminum chloride, triisobutylaluminum, diethylaluminum bromide, and diethylaluminum hydride. Among these, triethylaluminum and triisobutylaluminum are preferable.

Examples of the external electron donor compound used to produce the propylene polymerization catalyst described herein include an organic compound that includes an oxygen atom or a nitrogen atom. Examples of the organic compound that includes an oxygen atom or a nitrogen atom include an alcohol, a phenol and a derivative thereof, an ether, an ester, a ketone, an acid halide, an aldehyde, an amine, an amide, a nitrile, an isocyanate, and an organosilicon compound. The external electron donor compound may be an organosilicon compound that includes a Si—O—C linkage, an aminosilane compound that includes an Si—N—C linkage, or the like.

Examples of the external electron donor compound used to produce the propylene polymerization catalyst described herein include one or more organosilicon compounds selected from organosilicon compounds represented by a general formula (5):

R⁶_{q}Si(OR⁷)_{4-q}, (5)

wherein R⁶ is an alkyl group having 1 to 12 carbon atoms, a cycloalkyl group having 3 to 12 carbon atoms, a phenyl group, a vinyl group, an allyl group, an arylalkyl group, an alkylamino group having 1 to 12 carbon atoms, or a dialkylamino group having 1 to 12 carbon atoms, provided that a plurality of R⁷ are either identical to or different from each other when a plurality of R⁶ are present, R⁷ is an alkyl group having 1 to 12 carbon atoms, a cycloalkyl group having 3 to 6 carbon atoms, a phenyl group, a vinyl group, an allyl group, or an arylalkyl group, provided that a plurality of R⁷ are either identical to or different from each other when a plurality of R⁷ are present, and “q” is an integer from 0 to 3.

The propylene polymerization catalyst described herein may be produced by bringing the solid catalyst component for propylene polymerization obtained by the production method described herein, the organoaluminum compound, and the external electron donor compound into contact with each other using a known method.

The propylene polymerization catalyst described herein may be produced by bringing the solid catalyst component for propylene polymerization described herein, the organoaluminum compound, and the external electron donor compound into contact with each other in the absence of an olefin, or may be produced by bringing the solid catalyst component for propylene polymerization according to one embodiment, the organoaluminum compound, and the external electron donor compound into contact with each other in the presence of an olefin (i.e., in the polymerization system).

The method for producing a polypropylene described herein includes polymerizing an olefin in the presence of the propylene polymerization catalyst described herein.

The olefin that is polymerized using the method for producing a polypropylene described herein may be one or more olefins selected from ethylene, propylene, 1-butene, 1-pentene, 4-methyl-1-pentene, vinylcyclohexane, and the like. Among these, ethylene, propylene, and 1-butene are preferable, and propylene is more preferable.

Propylene may be copolymerized with another olefin. A desirable process may include subjecting the propylene and another a-olefin to random or block copolymerization. A “block copolymer” obtained by block copolymerization is a polymer that includes two or more segments in which the monomer composition changes sequentially. A block copolymer obtained by block copolymerization has a structure in which two or more polymer chains (segments) that differ in primary polymer structure (e.g., type of monomer, type of comonomer, comonomer composition, comonomer content, comonomer arrangement, and stereoregularity) are linked within one molecular chain. A “random copolymer” is a copolymer having a-olefin derived units distributed randomly throughout the polypropylene chain.

The olefin that may be copolymerized with propylene is preferably ethylene or an α-olefin having 4 to 20 carbon atoms. Specific examples of the olefin include ethylene, 1-butene, 1-pentene, 4-methyl-1-pentene, vinylcyclohexane, and the like. These olefins may be used either alone or in combination. Among these, ethylene, 1-butene and 1-hexene are preferable. The “polypropylenes” described herein may comprise from 0.1, or 0.2 to 1, or 2, or 5 wt % α-olefin derived units, where the remainder is propylene-derived units; or may comprise greater than 99, or 99.5, or 99.8, propylene-derived units, or may comprise 100% propylene derived units.

When implementing the method for producing a polypropylene described herein, the olefin may be polymerized in the presence or absence of an organic solvent, and may be used in a gaseous state or a liquid state.

The olefin may be polymerized in a single batch reactor (e.g., autoclave) in the presence of the propylene polymerization catalyst described herein while heating and pressurizing the mixture, for example.

When implementing the method for producing a polypropylene described herein, the polymerization temperature is normally set to 200° C. or less. The polymerization temperature is preferably set to 60 to 100° C., and more preferably 70 to 90° C., from the viewpoint of improving activity and stereoregularity. When implementing the method for producing a polypropylene described herein, the polymerization pressure is preferably set to 10 MPa or less, and more preferably 5 MPa or less.

A continuous polymerization method or a batch polymerization method may be used. The polymerization reaction may be effected in a single step, or may be effected in two or more steps.

The polypropylenes made by the process herein can be produced by any means of olefin polymerization. Most preferably, a single catalyst is used such as the magnesium/titanium catalyst component described above with one or more activators and/or external electron donors in a slurry polymerization system, preferably two external donors whose overall concentration can be varied, and/or varied with respect to one another.

The phrases “slurry polymerization process” or “slurry polymerization reactor” refer to a process or reactor that handles polypropylene that is only partly dissolved or not dissolved at all in the medium, either monomer, solvent, or both, typically having at least 20 wt % polypropylene suspended or not dissolved. In a typical solution or slurry polymerization process, catalyst components, solvent, monomers and hydrogen (when used) are passed under pressure to one or more polymerization reactors. Catalyst components may be passed to the polymerization reactor as a mixture in aliphatic hydrocarbon solvent, in oil, a mixture thereof, or as a dry powder. Most preferably, the polymerization process is otherwise carried out using propylene as the medium to carry the components and exchange heat with the environment.

The slurry polymerization process described herein is preferably a “slurry loop process.” In any embodiment, the magnesium/titanium catalyst component, an activator (typically an aluminum alkyl) and external electron donor(s) are fed to a pre-polymerization reactor, either with or without a prior step to premix or “pre-contact” these components to activate the catalyst complex ahead of polymerization. The pre-polymerization reactor serves to start the reaction with the monomer, typically propylene but also ethylene or other C4 to C12 olefins, at a low temperature (preferably 10-30° C.) to allow a small amount of polypropylene to grow around the catalyst particles to prevent fracturing, and thus create polypropylene fines which are difficult to process, when this catalyst with polypropylene is subsequently fed into the first main loop reactor along with more monomer and/or comonomers. However, in any embodiment, the pre-polymerization step is absent and the catalyst/activator/donors fed directly to the polymerization reactor(s). In any case, there may be one or two or more loop reactors in series or parallel, followed by separation equipment such as described herein to remove remaining monomers from the polypropylene solids which can then be “finished” in either extrusion and pelletization equipment or loaded to containers directly as the material comes from the reactors. The process is preferably a continuous slurry loop process such as disclosed in WO 2003/070365.

The polymerization is most preferably a “single stage” polymerization process, meaning that the olefins and catalyst components, and optional hydrogen are contacted under the same or similar conditions throughout the production of the polypropylene, such as in a single reactor, or multiple reactors in parallel or series, held at a constant level of temperature, pressure, monomer concentration, and hydrogen concentration, where no parameter changes by more than ±5%, or ±10%. Thus, for example, a polymerization is single stage even if performed in two or more slurry loop reactors in parallel if the reactor conditions are held at a constant level.

In any embodiment, hydrogen may be present in the reactor to modulate the molecular weight of the polypropylene being produced. In any embodiment, the hydrogen, if combined with the single catalyst during the polymerization, is combined at a constant level. This means that the total concentration of hydrogen in the reactor is held constant during the production of the polypropylene.

In any embodiment, the temperature of the reactor is controlled by the rate of catalyst addition (rate of polymerization), the temperature of the monomer feed stream and/or the use of heat transfer systems. For olefin polymerization, reactor temperatures can range from 50 to 120° C. or more, while pressures are generally higher than 300 psig, or within a range from 300 psig to 1000, or 1200 psig. These process conditions are in favor of in-situ catalyst activation since high temperature enhances the solubility of catalysts and activators in propylene. In any embodiment, the polymerization temperature is preferably at least 50, or 60, or 70° C., or within a range from 50, or 60, or 70, or 80, or 90, or 100, or 120° C. to 130, or 140, or 150, or 160, or 170° C.

Prior to mixing, the monomers are generally purified to remove potential catalyst poisons. The feedstock may be heated or cooled prior to delivery to the first reactor. Additional monomers may be added to the second reactor, and it may be heated or cooled.

The catalysts/activators/donors can be passed to one or more polymerization reactors in series or split between two or more reactors in parallel. In slurry polymerization, polypropylene produced remains dissolved or partially dissolved in the liquid monomer under reactor conditions. The catalyst may be passed to the reactor in solid form or as a slurry/suspension in an inert hydrocarbon solvent. Alternatively, the catalyst suspension may be premixed with the solvent in the feed stream for the polymerization reaction. Catalyst can be activated in-line, or by an activator with which it is co-supported. In some instances premixing is desirable to provide a reaction time for the catalyst components prior to entering the polymerization reactor, but this step may be absent. The catalyst activity is preferably 20,000 kg polypropylene per kg of catalyst or more, more preferably 50,000 kg polypropylene per kg of catalyst or more, even more preferably 100,000 kg polypropylene per kg of catalyst or more.

Loop reactor systems include a single reactor and multiple reactors in series or parallel configuration, such as that disclosed in US 2007/0022768. The solvent/monomer, preferably comprising (or consisting essentially of, or consisting of) propylene, flow in these reactors is typically maintained using pumps and/or pressure systems, and may operate continuously by having monomer and catalyst feed at one point and extracting the forming polypropylene from another point, preferably downstream therefrom. Diluents are preferably absent from the loop reactor and process to produce polypropylene, such as isobutene, pentane, n-butane, cyclohexane, and other common inert diluents. The conditions of temperature, catalyst concentration, hydrogen concentration, and monomer concentration may be the same or different in each loop reactor and may be tailored as necessary to suit the desired end product. In any embodiment, the solution polymerization process of this disclosure uses heat exchanger types of reactors where the polymerization. The reactors can be one or more shell and tube type of heat exchangers, or one or more spiral type of heat exchanger.

Most preferably, no solvents are present in the slurry loop process except for a minor amount used to initially suspend the catalyst and/or activator, and the system consists essentially of propylene and any other monomers as the polymerization medium and carrier of the forming polypropylene particles. In any embodiment the reactor pressure is maintained and/or controlled using a pressurization drum, which is an apparatus containing liquid propylene and fluidly connected to the loop reactor, preferably the first loop, where the propylene is kept under pressure. The pressure of the propylene within the pressurization drum is controlled by steam-heated propylene that can enter above a pool of liquid propylene in the drum.

So called monomer scrubbers (typically, counter-flow liquid/vapor apparatus) and mechanical dryers (typically, batch or continuous blenders such as from Bepex™ International LLC) are preferably absent from the slurry loop process, and monomer recovery relies upon transfer line dryers and separation systems such as those described herein, preferably a high pressure dust collector or “separator” (at least 200, or 250, or 300 psi), followed by a low pressure separator (1, or 5 psi to 10, or 20, or 50 psi), the geometry and size of which are tailored to increase residence time of the materials to effect separation of liquid propylene from solid polypropylene. Screw compressors, especially flooded screw compressors, may also be used to maintain or alter pressure and convey material. Preferably, propylene is removed from the solid polypropylene by passing both from the loop reactor to a transfer line dryer, preferably continuously, followed by a high pressure separator, followed in any embodiment by another transfer line dryer, then to a low pressure separator. The solid polypropylene that remains is then passed preferably to a purge drum, then the finishing process.

Thus, in any embodiment is a process comprising contacting a catalyst with propylene and ethylene or C4 to C10 α-olefins in at least one slurry polymerization reactor to produce polypropylene, wherein the process further comprising (or consisting of, or consisting essentially of) continuously separating the polypropylene from the remaining propylene by first passing the polypropylene and remaining propylene from the reactor(s) to a transfer line dryer to remove a portion of the propylene, preferably continuously, followed by passing the polypropylene and remaining propylene to a high pressure separator (i.e., liquid-solid separator) whereby an amount of the remaining propylene is further separated from a first separated polypropylene and directed to a recycle line to the reactor(s); directing the first separated polypropylene to a low pressure separator (i.e., gas-solid separator) whereby any remaining propylene is further separated to obtain a second separated polypropylene and propylene which is directed to a recycle line back to the reactor(s), wherein the second separated polypropylene is passed to a purge drum, then to an extruder to form finished pellets of polypropylene. In any embodiment, the first separated polypropylene and remaining propylene is passed to the low pressure separator through a second transfer line dryer to remove an amount of propylene prior to entering the low pressure separator.

Propylene recovered from the high pressure separator is preferably recycled back to the first, second, or both loops in the reactor, with or without further compression. Also, propylene recovered from the low pressure separator is also recycled back to the first, second, or both loops reactor, preferably with compression. Most preferably, no other separation means or steps to remove polymer from the propylene are taken in either recycle stream.

In finishing the polypropylene, one or more conventional additives such as antioxidants can be incorporated in the polypropylene during melt extrusion in one or more extruders. Possible antioxidants include phenyl-β-naphthylamine; di-tert-butylhydroquinone, triphenyl phosphate, heptylated diphenylamine, 2,2′-methylene-bis(4-methyl-6-tert-butyl)phenol, and 2,2,4-trimethyl-6-phenyl-1,2-dihydroquinoline, and/or stabilizing agents such as tocopherols or lactones, acid scavengers, and/or other agents as disclosed in WO 2009/007265.

The disclosure herein thus provides a novel method that can produce a polypropylene that exhibits a high melt flow rate (MFR), high stereoregularity, and excellent rigidity while achieving high yield.

In any embodiment the polypropylene that is produced using the solid catalyst component for propylene polymerization obtained by the production method described herein preferably has a xylene-soluble content (XS) (stereoregularity of α-olefin monomer chain) of 1.5 wt % or less, more preferably 1.0 wt % or less, and particularly preferably 0.8 wt % or less.

In any embodiment, the polypropylene has an isopentad level of at least 95, or 96, or 97, or 98, or 98.5% as measured by ¹³C NMR.

In any embodiment the polypropylene comprises (or consisting of, or consisting essentially of) a xylene soluble fraction of 1.5 wt % by weight of the polymer and soluble fraction or less, wherein the polypropylene has a melt flow rate within a range from 50, or 80, or 100, or 140 g/10 min to 220, or 300, or 400, or 500 g/10 min and a flexural modulus within a range from 1780 MPa to 2200 MPa.

The polypropylenes described herein are useful in many applications such as thermoformed, blow molded, injection molded, roto-molded, or extrusion-type articles. The polypropylenes can be used alone or blended with other polymers such as polyethylenes (LLDPE, HDPE, LDPE), plastomers, propylene-based elastomers, ethylene-propylene-diene rubbers, ethylene-propylene copolymers, butyl rubbers, styrenic copolymers and block copolymers, cyclic olefin copolymers, hydrocarbon resins, and other types of polypropylenes (e.g., lower MFR or higher MFR grades, lower tacticity, etc.), with or without curatives or other additives.

Such additional “additives” can include, for example, inorganic fillers (such as talc, glass, and other minerals), carbon black, nucleators, clarifiers, colorants (soluble and insoluble), foaming agents, antioxidants, alkyl-radical scavengers (preferably vitamin E or other to tocopherols and/or tocotrienols), anti-ultraviolet light agents, acid scavengers, curatives and cross-linking agents, mineral and synthetic oils, aliphatic and/or cyclic containing oligomers or polymers (and other “hydrocarbon resins”), and other additives well known in the art.

With respect to the polypropylenes or blends including the inventive polypropylenes, “consisting essentially of” means that the claimed polyolefin, composition and/or article includes the named components and no additional components that will alter its measured properties by any more than ±1, 2, 5, or 10%, and most preferably means that “additives” are present, if at all, to a level of less than 5, or 4, or 3, or 2 wt % by weight of the composition.

### EXAMPLES

The solid catalyst components and polypropylenes made therefrom are further described below by way of examples. Note that the following examples are for illustration purposes only, and the claims and disclosure are not limited to the following examples.

### Example 1

Synthesis of solid catalyst component. The steps to production in this example magnesium/titanium catalyst component are as follows:
(1) First Step

A 500 mL round bottom flask equipped with a stirrer in which the internal atmosphere had been sufficiently replaced by nitrogen gas, was charged with 40 mL of titanium tetrachloride and 60 mL of toluene (SP=8.9) to prepare a mixed solution. A suspension prepared using 20 g (175 mmol) of spherical diethoxymagnesium, 80 mL of toluene, and 1.8 mL (7.8 mmol) of di-n-propyl phthalate was added to the mixed solution and heated to 110° C. An amount of 3.6 mL (15.5 mmol) of di-n-propyl phthalate was added stepwise to the mixture while heating the mixture. After reacting the mixture at 110° C. for 2 hours with stirring, the reaction mixture was allowed to stand, and the supernatant liquid was removed to obtain a reaction product slurry. After the addition of 187 mL of toluene (SP=8.9) to the reaction product slurry, the mixture was stirred and allowed to stand, and the supernatant liquid was removed. This operation was performed four times to wash the reaction product to obtain a reaction product slurry including a solid catalyst component, the magnesium/titanium catalyst component.
(2) Second Step

An amount of 170 mL of toluene and 30 mL of titanium tetrachloride were added to the reaction product slurry including the solid catalyst component. The mixture was heated to 110° C., and reacted for 2 hours with stirring. After completion of the reaction, the supernatant to liquid was removed. An amount of 180 mL of toluene and 20 mL of titanium tetrachloride were added to the above reaction products and the mixture was heated to 80° C. and after that 0.5 mL (2.2 mmol) of di-n-propyl phthalate was added heated to 110° C., and reacted for 2 hours with stirring. The resulting reaction mixture was allowed to stand, and the supernatant liquid was removed to obtain a reaction product slurry. After completion of the reaction, 187 mL of toluene (SP=8.9) was added to the reaction product slurry, the mixture was stirred and allowed to stand, and the supernatant liquid was removed. This operation was performed twice to obtain a reaction product slurry including.
(3) Third Step

An amount of 187 mL of toluene was added to the reaction product slurry from the previous step to adjust the concentration of titanium tetrachloride in the reaction mixture to 1.3 wt %, and the mixture was heated to 80° C. After the addition of 0.5 mL (2.5 mmol) of diethyl phthalate, the mixture was heated to 100° C., and reacted for 1 hour with stirring. The resulting reaction mixture was allowed to stand, and the supernatant liquid was removed to obtain a reaction product slurry including a third solid component.
(4) Fourth Step

After the addition of 150 mL of o-dichlorobenzene (SP=10.0) to the third solid component from the previous step, the mixture was stirred at 90° C. for 1 hour, and allowed to stand, and the supernatant liquid was removed. This operation was performed twice to obtain a reaction product slurry. After the addition of 150 mL of n-heptane (SP=7.4) to the reaction product, the mixture was stirred, and allowed to stand, and the supernatant liquid was removed. This operation was performed seven times to wash the reaction product to obtain about 20 g of a solid catalyst component (A1) for propylene polymerization.

The solid catalyst component (A1) had a magnesium atom content of 19.9 wt %, a titanium atom content of 1.2 wt %, and a total phthalic acid diester content of 16.8 wt %.

The titanium content, and the content of the internal electron donor compound in the solid were measured as described below.

Titanium content in solid. The titanium content in the solid was measured in accordance with JIS G1319.

Content of electron donor compound in solid. The content of the electron donor compound in the solid was measured using a gas chromatograph (“GC-14B” manufactured by Shimadzu Corporation) under the following conditions. The number of moles of each component was calculated from the gas chromatography measurement results using a calibration curve that was drawn in advance using the measurement results at a known concentration. The measurement conditions were as follows:
Column: packed column (2.6 cm (diameter)×2.1 m, Silicone SE-30 10%, Chromosorb WAW DMCS 80/100, manufactured by GL Sciences Ltd.);
Detector: flame ionization detector (FID);
Carrier gas: helium, flow rate: 40 mL/min;
Measurement temperature: vaporization chamber: 280° C., column: 225° C., detector: 280° C.

Production of polymerization catalyst, and polymerization. An autoclave (internal volume: 2.0 L) equipped with a stirrer in which the internal atmosphere had been completely replaced by nitrogen gas, was charged with 1.32 mmol of triethylaluminum, 0.13 mmol of diethylaminotriethoxysilane (DEATES), and the solid catalyst component (A1) (0.0013 mmol on a titanium atom basis) to produce a propylene polymerization catalyst.

The autoclave was charged with 5.0 L of hydrogen gas and 1.4 L of liquefied propylene. After effecting preliminary polymerization at 20° C. for 5 minutes under a pressure of 1.1 MPa, a polymerization reaction was effected at 70° C. for 1 hour under a pressure of 3.5 MPa to obtain a propylene polymer (polypropylene).

The polymerization activity per gram of the solid catalyst component during the polymerization reaction, the p-xylene-soluble content (XS) in the polymer, the MFR of the polymer, and the flexural modulus (FM) of the polymer were measured as described below. The results are listed in Table 1.

Polymerization activity per gram of solid catalyst component. The polymerization activity per gram of the solid catalyst component was calculated using the following expression: Polymerization activity (g-PP/g-catalyst)=weight (g) of polymer/weight (g) of solid catalyst component.

Melt flow rate of polymer. The melt flow rate (MFR) of the polymer was measured in accordance with ASTM D1238 (JIS K 7210).

Xylene-soluble content (XS) in polymer. A flask equipped with a stirrer was charged with 4.0 g of the polymer (polypropylene) and 200 mL of p-xylene. The external temperature was increased to be equal to or higher than the boiling point (about 150° C.) of xylene, and the polymer was dissolved over 2 hours while maintaining p-xylene contained in the flask at a temperature (137 to 138° C.) lower than the boiling point. The solution was cooled to 23° C. over 1 hour, and an insoluble component and a soluble component were separated by filtration. A solution including the soluble component was collected, and p-xylene was evaporated by heating (drying) under reduced pressure. The weight of the residue was calculated, and the relative ratio (wt %) with respect to the polymer (polypropylene) was calculated to determine the xylene-soluble content (XS).

Carbon-13 Nuclear Magnetic Resonance. The isotactic pentad fraction (isopentads, mmmm) of the polymer was determined by performing ¹³C-NMR measurement using an NMR device (“JNM-ECA400” manufactured by JEOL Ltd.) under the following conditions:
Measurement mode: proton decoupling method
Pulse width: 7.25 μsec
Pulse repetition time: 7.4 sec
Integration count: 10,000
Solvent: tetrachloroethane-d2
Sample concentration: 200 mg/3.0 mL
Average meso run length was calculated by the following calculation method: The average meso run length=10,000/[(stereodefects/10,000 C)+(2,1-regio-defects/10000 C)+(1,3-regiodefects/10,000 C)].

Flexural modulus (FM) of polymer. The polymer was injection-molded to prepare a property measurement specimen in accordance with JIS K 7171. The specimen was conditioned in a temperature-controlled room maintained at 23° C. for 144 hours or more, and the flexural modulus (FM) (MPa) was measured using the specimen provided that a liquid/powder exudate was not observed on the surface thereof.

### Example 2

A solid catalyst component was synthesized, a polymerization catalyst was produced, and polymerization was effected in the same manner as in Example 1, except that an operation that adds 150 mL of o-dichlorobenzene (SP=10.0) to the reaction product slurry, stirs the mixture at 100° C. for 2 hours, allows the resulting reaction mixture to stand, and removes the supernatant liquid, was performed once, instead of performing the operation that adds 150 mL of o-dichlorobenzene to the reaction product slurry, stirs the mixture at 90° C. for 1 hour, allows the resulting reaction mixture to stand, and removes the supernatant liquid, twice (see “(4) Fourth step” in “Synthesis of solid catalyst component”). The results are listed in Table 1.

### Example 3

A solid catalyst component was synthesized, a polymerization catalyst was produced, and polymerization was effected in the same manner as in Example 1, except that 0.5 mL (2.0 mmol) of dimethyl diisobutylmalonate was used instead of 0.5 mL (2.2 mmol) of to di-n-propyl phthalate (see “(2) Second step” in “Synthesis of solid catalyst component”). The results are listed in Table 1.

### Comparative Example 1

A solid catalyst component was synthesized, a polymerization catalyst was produced, and polymerization was effected in the same manner as in Example 1, except that the fourth step was omitted (see “Synthesis of solid catalyst component”). The results are listed in Table 1.

### Comparative Example 2

A solid catalyst component was synthesized, a polymerization catalyst was produced, and polymerization was effected in the same manner as in Example 1, except that 150 mL of toluene (SP=8.9) was used instead of 150 mL of ODCB (SP=10.0) (see “(4) Fourth step” in “Synthesis of solid catalyst component”). The results are listed in Table 1.

### Comparative Example 3

A solid catalyst component was synthesized, a polymerization catalyst was produced, and polymerization was effected in the same manner as in Example 1, except that 150 mL of 1,2-dichloropropane (SP=9.0) was used instead of 150 mL of ODCB (see “(4) Fourth step” in “Synthesis of solid catalyst component”). The results of the example and comparative polypropylenes are listed in Table 1.

TABLE 1
Results of polymerization

| Exam- | Ti | Total Internal | Yield | XS | MFR | FM |
|---|---|---|---|---|---|---|
| ple PP | (wt %) | Donor (wt %) | (g-PP/g-cat) | (wt %) | (g/10 min) | (MPa) |
| 1 | 1.2 | 17.1 | 45,800 | 0.9 | 190 | 1,860 |
| 2 | 1.6 | 16.4 | 45,000 | 0.8 | 200 | 1,830 |
| 3 | 1.4 | 16.3 | 43,300 | 0.9 | 190 | 1,810 |
| C1 | 2.3 | 16.2 | 46,200 | 1.1 | 230 | 1,760 |
| C2 | 1.5 | 16.7 | 34,600 | 1.3 | 170 | 1,780 |
| C3 | 1.7 | 16.0 | 49,900 | 1.3 | 160 | 1,760 |

Inventive example 1 and 2 polypropylenes were found to exhibit 98.9 and 99.0% isopentads based on ¹³C NMR (respectively); comparative examples 1 and 2 exhibited a value of 98.3 and 98.4% isopentads (respectively). Since the solid catalyst component for propylene polymerization produced by the production method described herein is brought into contact with a magnesium compound, a tetravalent titanium halide compound, and one or more first internal electron donor compound to effect a reaction, and sequentially washed with a first inert organic solvent having an SP of 8.0 to 9.0, a second inert organic solvent comprising a hydrocarbon compound having an SP of more than 9.0, and a third inert organic solvent having an SP of less than 8.0 after completion of the reaction process, the solid catalyst component exhibits low adhesion to a support and a low interaction with an internal donor, and a titanium species having low stereospecificity has been efficiently removed. Therefore, the solid catalyst component can produce a polypropylene that exhibits a high rigidity of 1,800 MPa or more while maintaining high stereoregularity (i.e., can produce a polypropylene that exhibits both high stereoregularity and high rigidity).

Since the solid catalyst components for propylene polymerization produced by the production methods of Comparative Examples 1 to 3 were not washed with a second inert organic solvent comprising a hydrocarbon compound having an SP of more than 9.0, or are not sequentially washed with a first inert organic solvent having an SP of 8.0 to 9.0, a second inert organic solvent comprising a hydrocarbon compound having an SP of more than 9.0, and a third inert organic solvent having an SP of less than 8.0, a titanium species having low stereospecificity may remain in the solid catalyst component, or the balance between stereoregularity and rigidity deteriorates (i.e., it is impossible to produce a polypropylene that exhibits both high stereoregularity and high rigidity).

For all jurisdictions in which the doctrine of “incorporation by reference” applies, all of the test methods, patent publications, patents and reference articles are hereby incorporated by reference either in their entirety or for the relevant portion for which they are referenced.

1. A polypropylene comprising a xylene soluble fraction of 1.5 wt % by weight of the polymer and soluble fraction or less, wherein the polypropylene has a melt flow rate within a range from 50 g/10 min to 500 g/10 min and a flexural modulus within a range from 1780 MPa to 2200 MPa.

2. The polypropylene of claim 1, produced in a process comprising combining propylene and a solid magnesium/titanium catalyst component.

3. The polypropylene of claim 2, wherein the solid magnesium/titanium catalyst component comprises 1.6 wt % titanium or less.

4. The polypropylene of claim 1, having an isopentad level of at least 95%.

5. The polypropylene of claim 1, wherein the solid magnesium/titanium catalyst component was made a process comprising:
a) bringing a magnesium compound, a titanium halide compound, and one or more internal electron donor compounds into contact with each other to effect a reaction and form a reaction product; and
b) washing the reaction product one or more times with a first inert organic solvent to produce a first intermediate product, wherein the first organic solvent does not have reactivity with the titanium halide compound, and has a solubility parameter (SP) of 8.0 to 9.0.

6. The polypropylene of claim 5, further comprising:
c) washing the first intermediate product one or more times with a second inert organic solvent to produce a second intermediate product, wherein the second intern solvent comprises a hydrocarbon compound and does not have reactivity with the titanium halide compound, but has a SP of more than 9.0.

7. The polypropylene of claim 5, further comprising:
d) washing the second intermediate product one or more times with a third inert organic solvent that does not have reactivity with the titanium halide compound, and has a SP of less than 8.0, producing a solid magnesium/titanium catalyst component.
